(19) United States
(12) Patent Application Publication
(10) Pub. No.: US 2024/0232957 A9
(43) Pub. Date: Jul. 11, 2024

(54) METHOD AND SYSTEM OF FUNDRAISING FOR A POLITICAL CAMPAIGN

(71) Applicant: Data Vault Holdings, Inc., New York, NY (US)

(72) Inventors: Alfred Blair Blaikie, III, Tinton Falls, NJ (US); Nathaniel T. Bradley, Tucson, AZ (US); Joshua S. Paugh, Tucson, AZ (US)

(73) Assignee: Data Vault Holdings, Inc., New York, NY (US)

(21) Appl. No.: 18/491,560

(22) Filed: Oct. 20, 2023

Related U.S. Application Data
(60) Provisional application No. 63/380,513, filed on Oct. 21, 2022.

(51) Int. Cl. G06Q 30/0279; G06Q 10/02; G06Q 20/02

(52) U.S. Cl. CPC G06Q 30/0279; G06Q 10/02; G06Q 20/02; G06Q 2220/00

(57) ABSTRACT

The present disclosure includes a method of fundraising for a political campaign, including receiving a selection from a user to monetize data associated with a data object for benefit of a political campaign, compiling the data associated with the data object, generating a security token including a reference to the data object, monetizing the data object utilizing the security token in accordance with the selection. The data associated with the data object may include data independently obtained from the political campaign and associated with the user.

### RELATED APPLICATIONS

This application claims priority to U.S. Provisional Patent Application No. 63/380,513, filed on Oct. 21, 2022 and entitled “METHOD AND SYSTEM OF FUNDRAISING FOR A POLITICAL CAMPAIGN”, hereby incorporated by reference in its entirety.

### BACKGROUND

### I. Field of the Disclosure

The illustrative embodiments relate to data management, valuation and monetization systems. More specifically, but not exclusively, the illustrative embodiments relate to a system, method, apparatus, and platform for the valuation, management, and utilization of objectified data objects associated with political campaign fundraising.

### II. Description of the Art

In recent years, data security, cyber-attacks and big data breaches have led to the development of technology initiatives to secure data and make it available for users, including blockchain, cryptocurrencies, fire walls, and security and encryption technologies. These technologies have largely fallen short of protecting or properly capturing all the available consumer data. The commercial Internet is still largely dependent on digital advertisement revenue derived from user or personal data that is typically monetized through advertising and resulting consumer or commercial product sales. User data is being captured, searched and used in targeted ad revenue production and delivery by the big data companies. Search engines, web destinations, and physical real-world sources of data are abundant and grossly underserved in the fields of capture, valuation, and monetization. Big data companies collect, analyze, verify, and sell consumer data across all known web environments. The data is monetized by collecting and tracking interactions across an array of platforms, sites, devices, questionnaires, surveys and so forth.

Often, the current mechanisms fall short in the ability to price the resulting data and do not provide accurate data capture or network or exchanges for data purchasing, development, and transaction. Consumers' online profile data is commonly generated and monetized from consumer web searches, profile data, social media profiles, and online surveys that generate revenue through advertisement delivery with no compensation to the actual owners of the data, the individual consumers/users, consumer groups, organizations, and data generators themselves.

A set of seemingly unrelated problems to one not having the benefit of this disclosure relates to problems facing political campaigns. In a technology-driven world, political campaigns may struggle to engage with supporters in meaningful ways. This problem was further exacerbated during the pandemic when in-person campaign events may have been cancelled or attendance was limited.

What is needed are technological solutions for politicians and political campaigns to own and control their data, image, and likeness which helps facilitate connectivity and engagement with supporters and enhance fundraising efforts.

### BRIEF SUMMARY

Therefore, it is a primary object, feature, or advantage to improve over the state of the art.

It is a further object, feature, or advantage to provide for data management for political campaigns.

It is a still further object, feature, or advantage to provide for data valuation for political campaigns.

It is another object, feature, or advantage to provide for monetization of data for political campaigns.

It is another object, feature, or advantage to use technology-driven solutions to enhance fundraising for political campaigns.

A further object, feature, or advantage is to increase or enhance technology-driven engagement between political campaigns and supporters of political campaigns.

One more of these and/or other objects, features, or advantages will become apparent from the specification and claims that follow. No single embodiment need meet or exhibit each and every object, feature, or advantage. Different embodiments may have different objects, features, or advantages.

Embodiments of the illustrative embodiments may include a method of fundraising for a political campaign, including receiving a selection from a user to monetize data or name, image, and likeness (NIL) content associated with a data object for benefit of a political campaign. Embodiments may also include compiling the data associated with the data object. Embodiments may also include generating a security token including data or information, such as an ownership record, crypto anchor, and reference to the data object. Embodiments may also include monetizing the data object utilizing the security token in accordance with the selection. In some embodiments, the data associated with the data object includes data independently obtained from the political campaign and associated with the user.

In some embodiments, the security token may be a blockchain-based token utilized by a blockchain platform. In some embodiments, the data object includes one or more profiles or other NIL content associated with the user, a website, an application, or a service. In some embodiments, at least one of the one or more profiles includes the data independently obtained from the political campaign.

In some embodiments, the method may include storing the data object in a virtual vault or other secure storage associated with the political campaign. Embodiments may also include creating access or access denial information to the data object referenced in the security token. In some embodiments, the method may include electronically sending a receipt to the user for contribution of the data associated with the data object.

In some embodiments, the data independently obtained from the political campaign organization associated with the user may include outreach and engagement data for the user within the political campaign. In some embodiments, the engagement data may include at least one of campaign event attendance, campaign donations, political party donations, and campaign participation.

In some embodiments, the data independently obtained from the political campaign may include engagement data on one or more digital platforms of the political campaign. In some embodiments, the method may include trading the security token on a data exchange in exchange for monetary value. In some embodiments, the method may include minting non-fungible tokens (NFTs) to at least one immutable ledger and recording the minted NFT in the NFT registry. In some embodiments, entries in the NFT registry correspond to programmatically defined smart contracts written to the at least one immutable ledger.

In some embodiments, the NFTs tokenize media files associated with the political campaigns. In some embodiments, the programmatically defined smart contracts define tickets for access to campaign events. In some embodiments, the method may include generating a data refinery based on campaign data and tokenizing the campaign data to provide. In some embodiments, the method may include monetizing the campaign data.

Embodiments may also include a monetization platform for a political campaign including a plurality of computer systems connected via a network, where the plurality of computer systems, form at least one immutable ledger. Embodiments may also include provide a non-fungible token (NFT) registry, where entries in the NFT registry correspond to programmatically defined smart contracts written to the at least one immutable ledger. This process also accounts for the registration and ownership of NIL content, data or an NFT associated with a campaign or user.

In some embodiments, at least one of the computer systems may be configured as an NFT registry service, where the NFT registry service may be capable of validating ownership via the registry and authenticating a representative of the political campaign based in part on input received from the representative of the political campaign through the user interface. Embodiments may also include receiving a media file through the user interface.

Embodiments may also include receiving parameters for use in programmatically defining, validating, and executing smart contracts. In some embodiments, the parameters include at least one political campaign supporter, benefit, donation, activity, record of ownership, or so forth. Embodiments may also include minting NFTs to the at least one immutable ledger and recording the minted NFT in the NFT registry, where minted NFTs may be cryptographically co-signed by the NFT registry service and an authenticated representative of the political campaign.

In some embodiments, the at least one political campaign support benefit includes a data object including a ticket to a campaign benefit. In some embodiments, the ticket may include an image of a two-dimensional bar code, inaudible tone, or crypto anchor for encoding ticket data. In some embodiments, the at least one political campaign support benefit includes a data object including a coupon code for use to redeem at an online store for a physical or virtual campaign item. In some embodiments, the physical campaign item may include at least one of a virtual item or real world item such as a sticker, a button, a sign, a shirt, and a hat.

Embodiments of the present disclosure may also include a method of outreach or fundraising for a political campaign, including authenticating a representative of the political campaign based in part on input received from the representative of the political campaign through a user interface generated by a computing device. Embodiments may also include receiving a media file through the user interface.

Embodiments may also include receiving parameters through the user interface, the parameters for use in programmatically defining, instructing and executing smart contracts. In some embodiments, the parameters include at least one political campaign supporter benefit. Embodiments may also include minting a non-fungible token (NFT). In some embodiments, the NFT identifies a data object including the media file and corresponds with programmatically defined smart contracts based on the parameters.

In some embodiments, the method may include selling the NFT to a campaign supporter. In some embodiments, the at least one political campaign support benefit includes a ticket to a campaign benefit, the ticket contained within the data object. In some embodiments, the ticket may include an image of a two-dimensional bar code encoding ticket data.

In some embodiments, the at least one political campaign support benefit includes a coupon code for use to redeem at an online store for a physical campaign item, the coupon code contained within the data object. In some embodiments, the physical campaign item may include at least one of a sticker, a button, a sign, a shirt, and a hat.

### BRIEF DESCRIPTION OF THE FIGURES

FIG. 1 is a flowchart illustrating a method of fundraising, according to some embodiments of the present disclosure.

FIG. 2 is a flowchart further illustrating the method of fundraising from FIG. 1, according to some embodiments of the present disclosure.

FIG. 3 is a flowchart further illustrating the method of fundraising from FIG. 1, according to some embodiments of the present disclosure.

FIG. 4 is a flowchart further illustrating the method of fundraising from FIG. 1, according to some embodiments of the present disclosure.

FIG. 5 is a block diagram illustrating a monetization platform, according to some embodiments of the present disclosure.

FIG. 6 is a block diagram further illustrating the monetization platform from FIG. 5, according to some embodiments of the present disclosure.

FIG. 7 is a block diagram further illustrating the monetization platform from FIG. 5, according to some embodiments of the present disclosure.

FIG. 8 is a flowchart illustrating a method of fundraising, according to some embodiments of the present disclosure.

FIG. 9 is a block diagram further illustrating one example of a system.

FIG. 10 is a diagram further illustrating one example of a system.

FIG. 11 is a block diagram of a platform for monetizing data in accordance with an illustrative embodiment.

FIG. 12 is a flowchart of a process for processing tokens.

### DETAILED DESCRIPTION

Various aspects of associated with a political campaign's use of data management, valuation and monetization systems are shown and described herein. Although different embodiments may be shown and described separately, it is to be understood that various embodiments may be combined.

In some embodiments, data, content, NIL, and NFT's, associated with a user may be tokenized and monetized for the benefit of the political campaign. In particular, a campaign supporter may consent to having their data, name, image or likeness, collected, tokenized and monetized for the benefit of the political campaign. This may include data related to web site visits, social media activity, purchasing activity, or other types of data. Note that such data is already collected about individuals through various tracking mechanism. Such data can be valuable to marketers. Here, instead of third parties collecting and selling such data, the user allows for collecting the data and can then monetize it for the benefit of a political campaign.

The illustrative embodiments provide a system, method, and platform for tokenizing content for political candidates, political organizations, non-profits, and/or political groups. Content or NIL content whether real, virtual, or idea-based may be captured in non-fungible tokens, a dedicated cryptocurrency, and/or blockchain tokens. The organization may utilize the tokenized content for political contributions, specific projects (e.g., building, water wells, clothing donations, disaster relief, etc.), or other needs. The tokens may also be exchanged donation of time, for work, service hours, in-kind contributions, surveys, phone calls, attendance at services/events, and so forth. One or more exchanges may also be utilized to register ownership and create value and a market for the tokens. The illustrative embodiments may combine the best practices and outcomes of political organizations, blockchain, and virtual and augmented reality (e.g., metaverse, virtual platforms, etc.). The additional methods of reaching the general public, partisans, opposing party members, independent voters, and other individuals for fundraising, receiving, donations, or enhancing experiences are very important to various types of organizations.

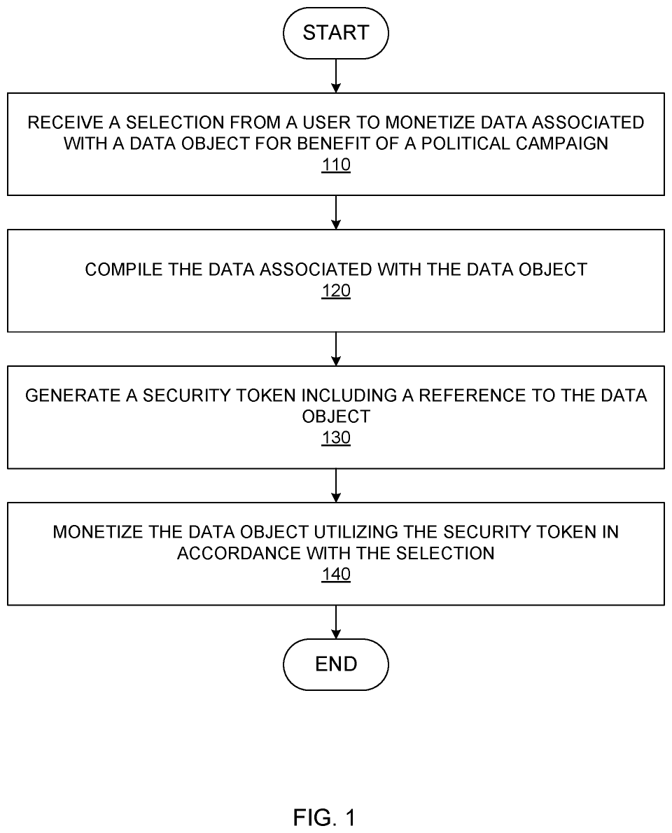

FIG. 1 is a flowchart that describes a method of fundraising, according to some embodiments of the present disclosure. In some embodiments, at 110, the method may include receiving a selection from a user to monetize data associated with a data object for benefit of a political campaign. The selection may specify the data to be compiled or limitations on the data to be compiled. The data object may include profile data for a user based on online activity such as web site activity, social media activity, purchasing activity, or other types of activity. At 120, the method may include compiling the data associated with the data object. This may be complied in various ways. In some embodiments, a user may install a software application on their computer or mobile device. The software application may be an add-on to a browser or other type of software application which may be used to compile a user's online activity. The data object which is compiled contains data associated with the user such as online activity. At 130, the method may further include generating a security token including a reference to the data object. At 140, the method may include monetizing the data object utilizing the security token in accordance with the selection. The data associated with the data object may include data independently obtained from the political campaign and associated with the user. In some embodiments, the data independently obtained from the political campaign comprises engagement data on one or more digital platforms of the political campaign. The data obtained from the political campaign may include data regarding participation at campaign events, political donations, volunteer efforts for the campaign, or other data which the campaign has collected, is associated with the campaign supporter, and which the campaign has the right to use.

In some embodiments, the data object may include a blockchain crypto anchor tied to one or more data points or profiles associated with the user, a website, an application, or a service. At least one of the one or more profiles may include the data independently obtained from the political campaign. In some embodiments, the security token may be a blockchain-based token utilized by a blockchain platform. The security token may also contain a secondary crypto anchor identifier such as a tone or other authentication validator.

In some embodiments, the method may include marketing, trading or monetizing the security token on a data exchange in exchange for monetary value or some other form of compensation or action. For example, advertisers or advertising networks may be interested in purchasing rights to use the data. Thus, one form of fundraising for the political campaign is to have campaign supports contribute the value of their data to the campaign in this fashion.

In addition to security tokens as described, the political campaign may fundraise through the creation and sale of non-fungible tokens (NFTs) for the political campaign. The NFTs may have data objects associated therewith which may include media files such as NIL content or images of political memes, images of political campaigns, audio recordings of political endorsements, political slogans, political speeches. In some embodiments the media files function as digital collectibles and supporters may wish to acquire not only to support the political campaign but in recognition that the NFTs may increase in monetary value over time due to scarcity.

In some embodiments, the method may include minting non-fungible tokens (NFTs) to at least one immutable ledger and recording the minted NFT and ownership of the NFT in the NFT registry. Entries in the NFT registry may correspond to programmatically defined smart contracts written to the at least one immutable ledger. In some embodiments, the NFTs may tokenize media files associated with the political campaigns. In some embodiments, the programmatically defined smart contracts may define tickets for access to campaign events, coupon codes to redeem for campaign merchandise or other types of campaign supporter benefits.

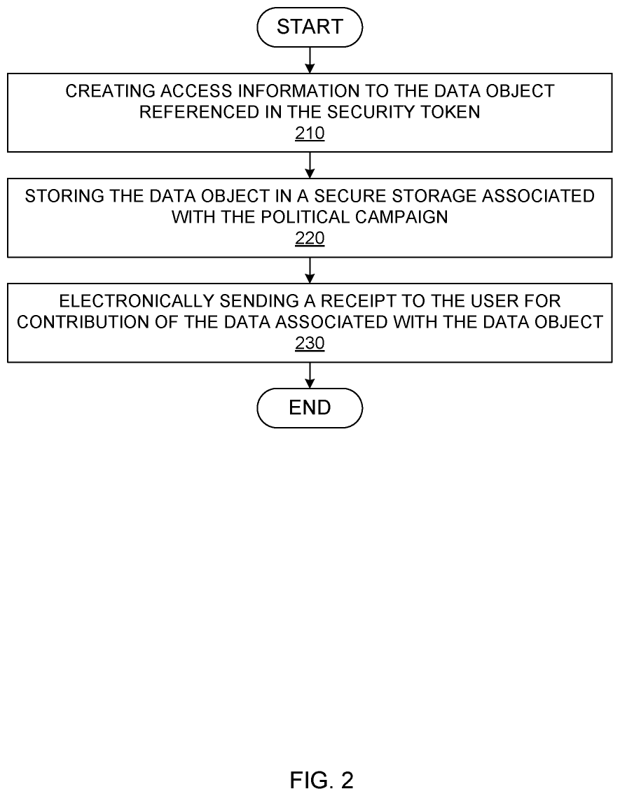

FIG. 2 is a flowchart that further describes the method of fundraising from FIG. 1, according to some embodiments of the present disclosure. In some embodiments, at 210, the method may include creating access information to the data object referenced in the security token. At 220, the method may include storing the data object in a secure storage associated with the political campaign. In some embodiments, at 230, the method may include electronically sending a receipt to the user for contribution of the data associated with the data object.

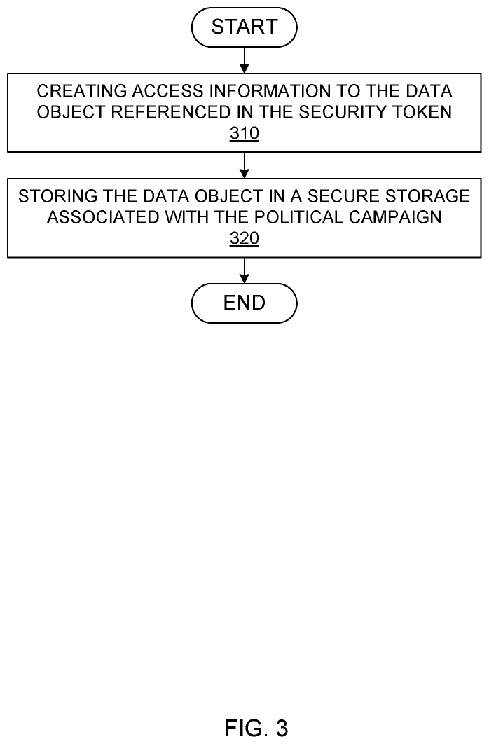

FIG. 3 is a flowchart that further describes the method of fundraising from FIG. 1, according to some embodiments of the present disclosure. In some embodiments, at 310, the method may include creating access information or a crypto anchor to the data object referenced in the security token. At 320, the method may include storing the data object in a secure storage associated with the political campaign. In some embodiments, the data independently obtained from the political campaign organization associated with the user comprises engagement data for the user within the political campaign. In some embodiments, the engagement data comprises at least one of campaign event attendance, campaign donations, political party donations, and campaign participation.

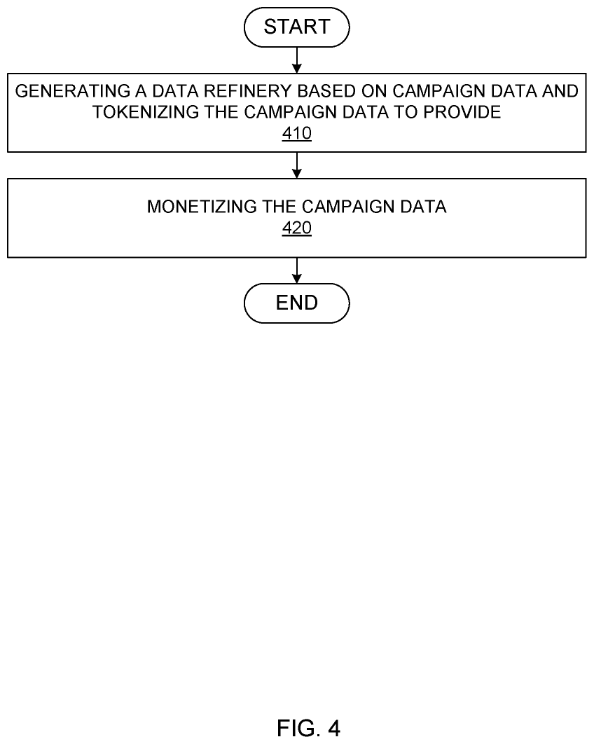

FIG. 4 is a flowchart that further describes the method of fundraising from FIG. 1, according to some embodiments of the present disclosure. In some embodiments, at 410, the method may include generating a data refinery based on campaign data and tokenizing the campaign data. In some embodiments, at 420, the method may include monetizing the campaign data.

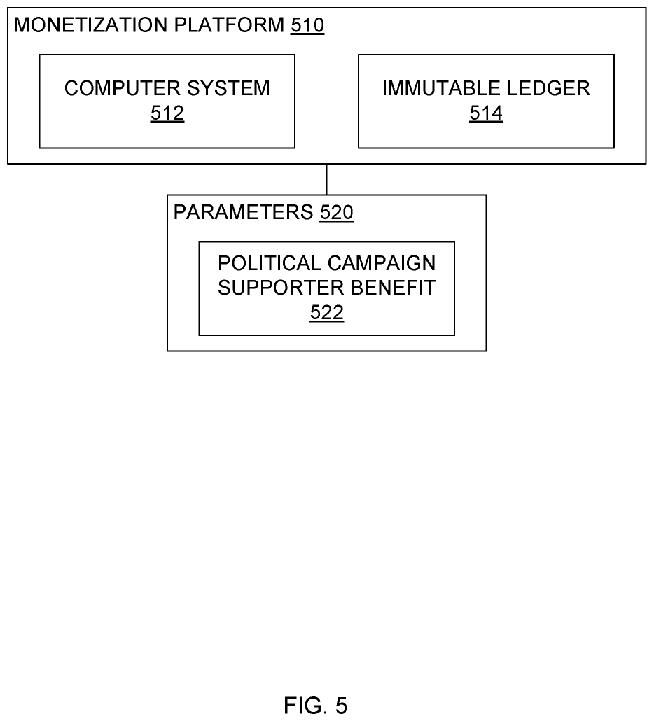

FIG. 5 is a block diagram that describes a monetization platform 510, according to some embodiments of the present disclosure. In some embodiments, the monetization platform 510 may include form 514 at least one immutable ledger. The monetization platform 510 may also include a plurality of computer systems 512 connected via a network, where the plurality of computer systems 512 provide a non-fungible token (NFT) registry, where entries in the NFT registry correspond to programmatically defined smart contracts written to the at least one immutable ledger.

In some embodiments, at least one of the computer systems 512 may be configured as an NFT registry service, where the NFT registry service may be capable of authenticating a representative of the political campaign based in part on input received from the representative of the political campaign through the user interface. The NFT registry service may further be capable of receiving a media file through the user interface and receiving parameters 520 for use in programmatically defining data ownership via the smart contracts. The NFT registry service may further be capable of minting NFTs to the at least one immutable ledger and recording the minted NFT in the NFT registry, where minted NFTs may be cryptographically co-signed by the NFT registry service and an authenticated representative of the political campaign. The parameters 520 may include at least one political campaign supporter benefit 522.

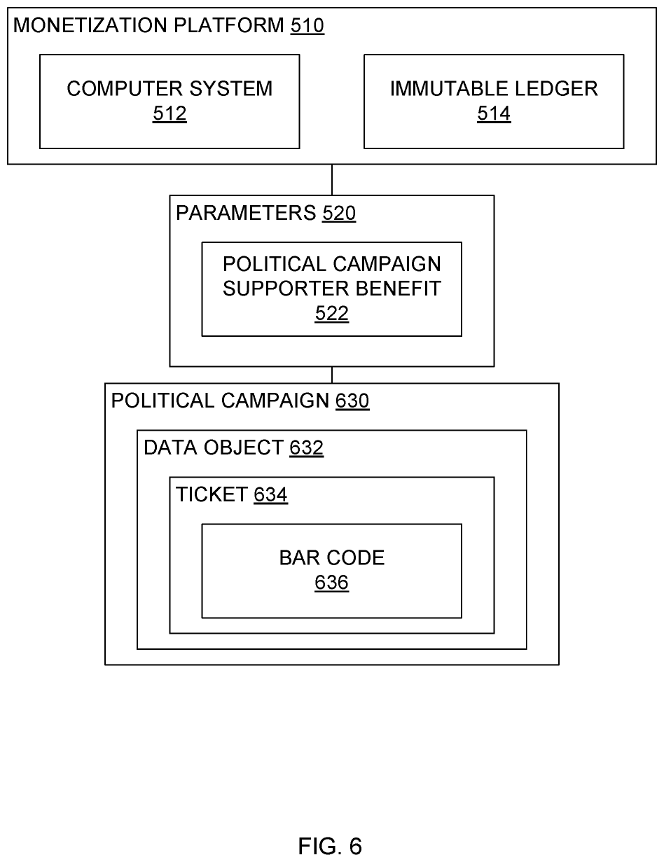

FIG. 6 is a block diagram that further describes the monetization platform 510 from FIG. 5, according to some embodiments of the present disclosure. In some embodiments, the at least one political campaign 630 may include a data object 632. The data object 632 may include a ticket 634 to a campaign benefit. In some embodiments, the ticket 634 may include an image 636 of a two-dimensional bar code such as a QR code or tone based ticketing implementation which encodes ticket data such as to admit a person to an event such as a campaign rally, a campaign private dinner, or other type of campaign event.

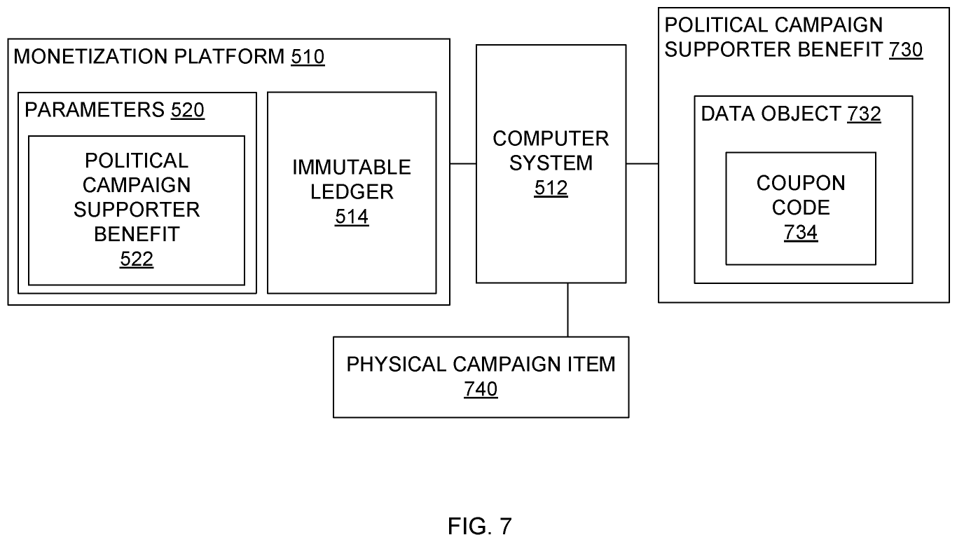

FIG. 7 is a block diagram that further describes the monetization platform 510 from FIG. 5, according to some embodiments of the present disclosure. In some embodiments, the at least one political campaign support benefit 730 may include a data object 732. The data object 732 may include a coupon code 734 for use to redeem at an online store for a physical campaign item 740. In some embodiments, the physical campaign item may include at least one of a virtual item or sticker, a button, a sign, a shirt, and a hat. Of course, any number of other campaign items may be included.

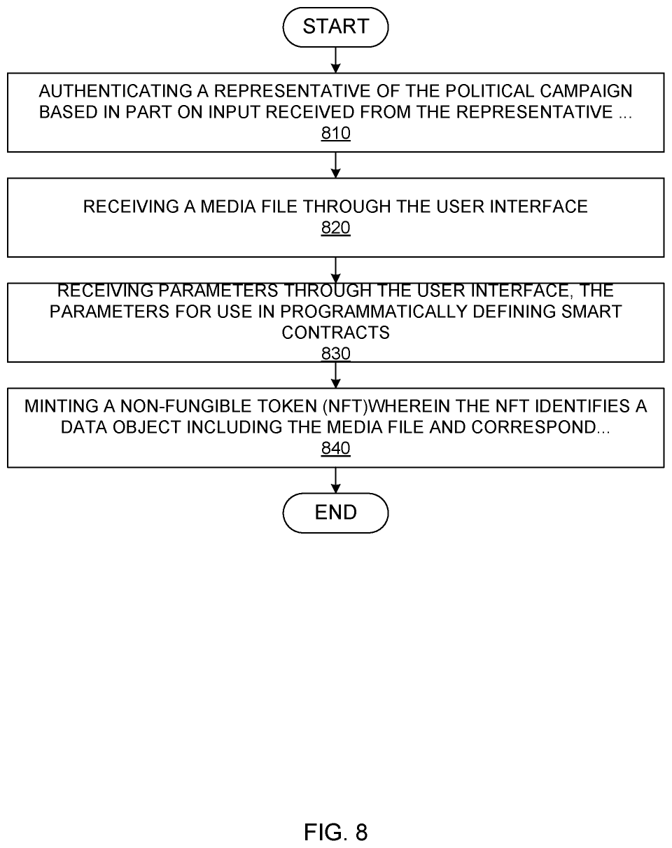

FIG. 8 is a flowchart that describes a method of fundraising, according to some embodiments of the present disclosure. In some embodiments, at 810, the method may include authenticating a representative of the political campaign based in part on input received from the representative of the political campaign through a user interface generated by a computing device. At 820, the method may include receiving a media file through the user interface. At 830, the method may include receiving parameters through the user interface, the parameters for use in programmatically defining smart contracts. At 840, the method may include minting a non-fungible token (NFT) wherein the NFT identifies a data object including the media file and corresponds with programmatically defined records of ownership, smart contracts or other crypto anchors based on the parameters. The parameters may include at least one political campaign supporter benefit.

In some embodiments, the method may include selling the NFT to a campaign supporter. In some embodiments, the at least one political campaign support benefit may include a ticket to a campaign benefit, the ticket contained within the data object. In some embodiments, the ticket may comprise an image of a two-dimensional bar code encoding ticket data. In some embodiments, the at least one political campaign support benefit may include a coupon code for use to redeem at an online store for a physical campaign item, the coupon code contained within the data object. In some embodiments, the physical campaign item comprises at least one of a sticker, a button, a sign, a shirt, and a hat.

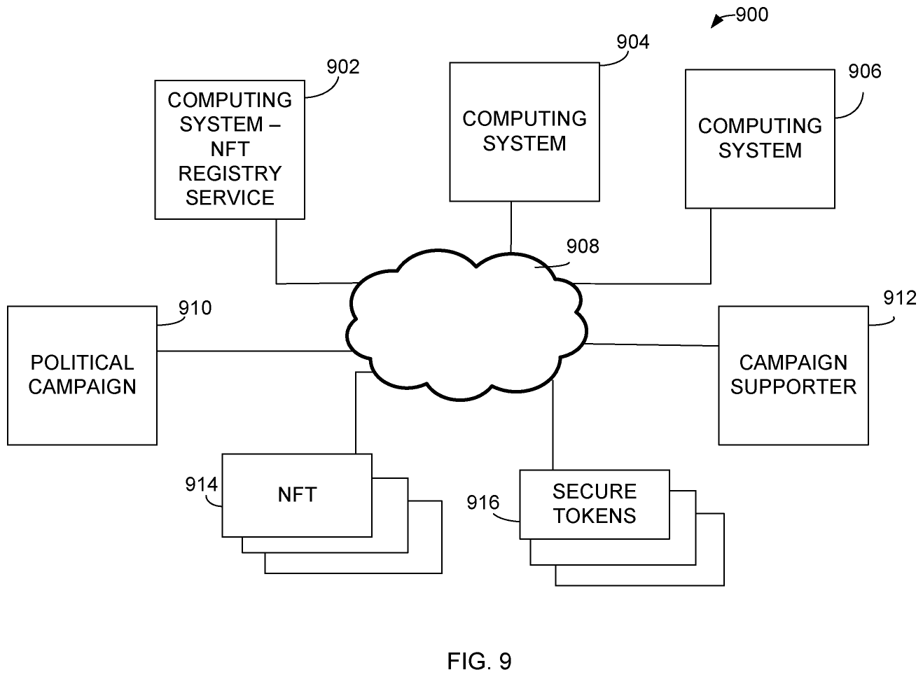

FIG. 9 illustrates another example of a system 900 for fundraising for a political campaign. A plurality of computing systems 902, 904, 906 are shown. Each computing system may have one or more processors for executing software instructions and a memory for storing the software instructions. At least one of the computing systems 902 may provide an NFT registry service such as that previously described. Each of the computing systems 902, 904, 906 may be operatively connected to a cloud network 908. Computing systems associated with the political campaign 910 and a campaign supporter 912 may also be operatively connected to the cloud network 908. An NFT 914 and secure tokens 916 are shown. The NFT 914 may be of the type previously described. The secure token 916 may be of the type previously described.

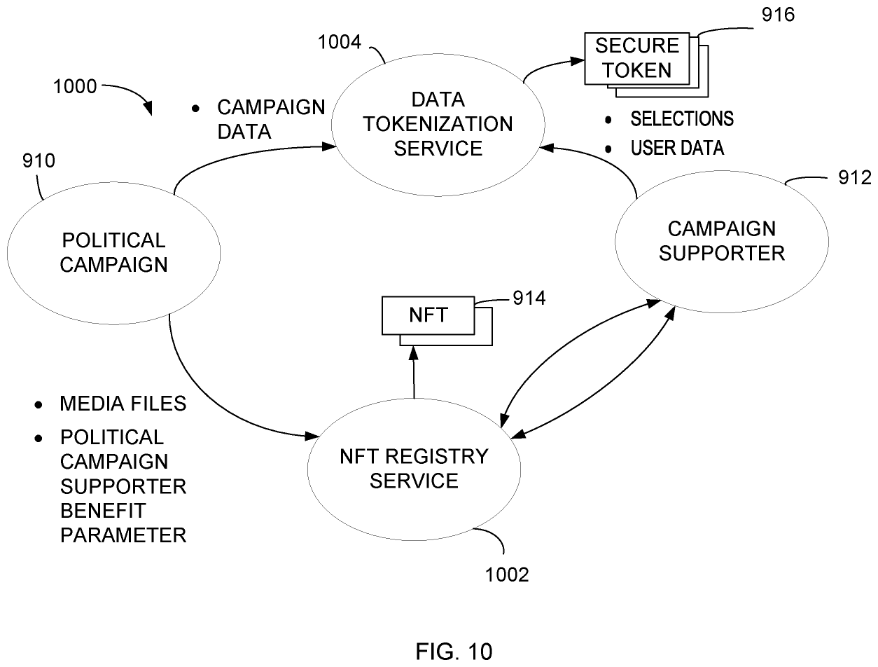

FIG. 10 illustrates another example of a system 1000 for fundraising for a political campaign in order to show aspects of information flow. A computing system associated with a political campaign 910 is shown as well as a computing system associated with a campaign supporter 912. A data tokenization service 1004 is shown along with a NFT registry service 1002. NFTs 914 and secure tokens 916 are also shown. The NFTs may include references to data objects such as media files. There may be smart contracts associated with the NFTs which may be defined programmatically based on parameters such as political campaign supporter benefit parameters defined by a political campaign. As shown in FIG. 10, the data tokenization service 1004 may provide for the tokenization of data based on selections made by the user and the user data received from the campaign supporter 912. In some embodiments, the selections may include which consent to the inclusion of data independent collected by the political campaign about the user. In addition, in some embodiments, the political campaign 910 may provide campaign data to the data tokenization service which includes data associated with the campaign supporter. Once security tokens 916 are created, monetization may be performed by exchanging the security tokens on an exchange or selling the security tokens to advertises for use in advertising with the benefit being received by the political campaign 910.

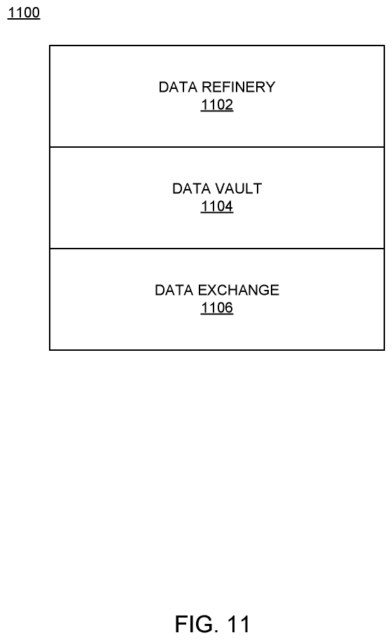

FIG. 11 is a block diagram of a platform 1100 for monetizing data in accordance with an illustrative embodiment. The platform 1100 may include a data refinery 1102, a data vault 1104, and a data exchange 1106. The platform 1100 of FIG. 11 may be representative of one or more devices, such as the servers 116, data platform of FIG. 1, or other smart networked device implementing specific hardware, software, firmware, and/or sets of instructions. The platform 1100 including the data refinery 1102, data vault 1104, and the data exchange 1106 may function as separate platforms or an integrated platform.

The data refinery 1102 is utilized to create data objects and capture applicable data to include the data objects. In one embodiment, the data refinery 1102 may be positioned within the user's existing system to capture data that is already received, entered, gleaned, or otherwise determined by the existing system. The data object may be created to store all, portions, or types of data associated with the user (e.g., individual, couple, family, company, organization, group, entity, etc.).

The data vault 1104 is utilized to securely store the data objects and add, modify, and improve the associated data. In one embodiment, the data vault may be utilized to collect, characterize, and value the data. The data vault 1104 may also determine the pace at which new data objects are added or updated as well as the types of data. For example, the data vault 1104 may determine that information relevant to two of the user's clients including company preferences for wireless services and legal services are added to the data vault 1104 each day. The data vault 1104 may be a physical or virtual storage and vault that securely stores information. In one embodiment, the data objects may be deidentified to remove identifying information to prevent hacking, identity theft, and other unwanted or prohibited utilization of data. The data vault 1104 may also assign an initial value for the data object. The value may be associated with similar data, going rates, completeness of the data, the type of data, the user supplying the data, historical information, and so forth. The value may change at any time based on a determination of the platform 1104 (i.e., the data vault or data exchange).

The data exchange 1106 is utilized to price and perform transactions for the data objects. In one embodiment, the data exchange 1106 creates a ticker associated with the data object. The ticker may be associated with the data object(s) for a user. The data exchange 1106 allows the data objects to be priced and purchased. In one embodiment, the exchange may utilize secure tokens to access the data. For example, transactions involving the data may represent a key for accessing the purchased or leased data. For example, the tokens may include an encryption key, password, biometric, or other secure identifier for accessing the data object from the data vault or other stored location.

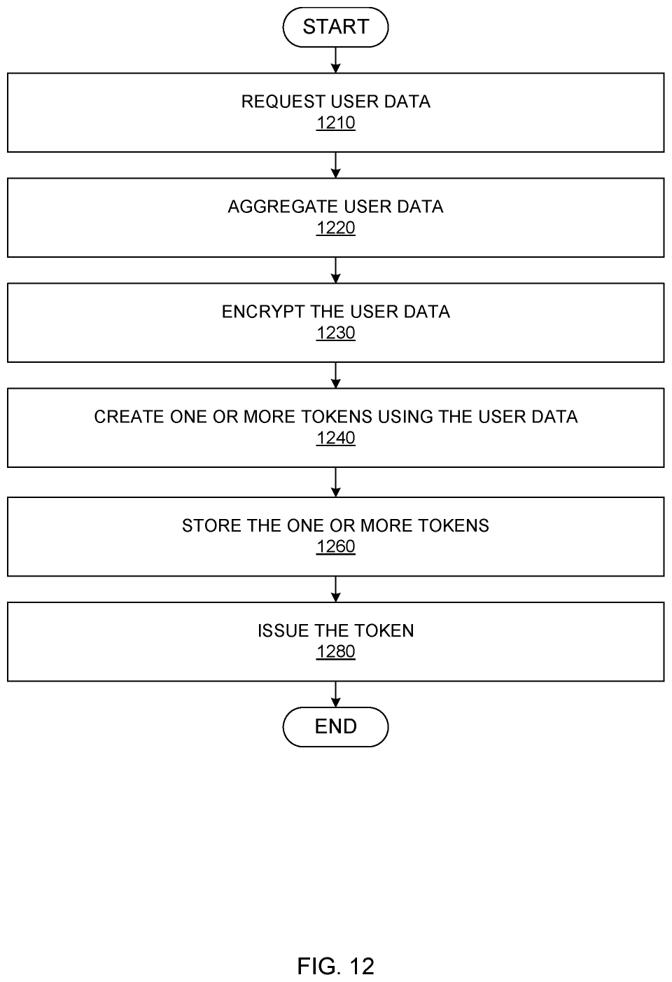

FIG. 12 is a flowchart of a process for processing tokens. All or portions of the process of FIG. 12 may be implemented without user interaction or with minimal user interaction. For example, user or campaign preferences and profiles may be utilized to perform the method herein described. The various systems, platforms, or devices herein described may be utilized to perform the method. The system may utilized customized applications, processes, algorithms, user interfaces, and software to implement the various embodiments.

The process may begin by requesting user data (step 1210). As noted, the user data may be politician data, campaign data, or individual user data. The user or entity may provide information specifying how, when, and where the data may be utilized and monetized including restrictions on monetization. The request may automatically go out from the system to devices, profiles, and accounts associated with the user to start collecting and aggregating the data.

Next, the system aggregates user data (step 1220). As described the data may be applicable to a user/politician, campaign, or so forth. The system may automatically retrieve the data through accounts, profiles, messages, software, devices, or so forth. In one embodiment, the system may utilize artificial intelligence or machine learning to automatically aggregate the user data based on the permissions, settings, profile, account, or other applicable information.

Next, the system encrypts the user data (step 1230). The user data is encrypted for protection. Any number of encryption algorithms and schemes and cryptographic techniques may be utilized. For example, asymmetric encryption may be utilized for all communications by the system. Cryptographic hash functions (e.g., SHA-256) may also be utilized to protect the user data/tokens.

Next, the system creates one or more tokens using the user data (step 1240). The user data may be stored directly in the one or more tokens. In another embodiment, the user data may stored separately from the token and instead the token may be the key to access the user data from a secure location (e.g., secured website, server, cloud network, etc.).

Next, the system stores the one or more tokens (step 1260). The one or more tokens may be stored in a data repository. For example, the repository may be a distributed ledger (e.g., blockchain ledger) or a secure cloud-based storage system.

Next, the system issues the token (step 1280). Next, the system issues the token to the applicable party granting them access and control over the user data encapsulated or accessible through the token. The party may receive a digital representation or physical representation of the token, such as a cryptographic key, unique, identifier, USB drive, or so forth, which may be used to access and manage the user data. The user may be provided with instructions on how to use the token and how to manage their data securely.

Therefore, various, methods, apparatuses, and systems have been shown and described. Although specific examples have been shown and described, numerous options, variations, and alternatives are contemplated. For example, where specific user interfaces are shown or user input is sought or information is to be displayed to a user, it is to be understood that these user interfaces may be constructed to display or collect information through any number of visual user interface components. In addition, user interfaces need not be visual in nature, but may be based on audio input or other types of input, or multi-modal input.

The methods described herein or aspects thereof may be incorporated into software in the form of instructions stored on a non-transitory computer or machine readable medium.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments may be described herein as implementing mathematical methodologies including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules. Where the term “processor” is used, it is to be understood that it encompasses one or more processors whether located together or remote from one other.

Similarly, the methods described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location, while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location. In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present), and B is false (or not present), A is false (or not present), and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Reference throughout this specification to “an example” means that a particular feature, structure, or characteristic described in connection with the example is included in at least one embodiment. Thus, appearances of the phrases “in an example” in various places throughout this specification are not necessarily all referring to the same embodiment.

1. A method of fundraising for a political campaign, comprising:
receiving a selection from a user to monetize data associated with a data object for benefit of a political campaign;
compiling the data associated with the data object;
generating a security token including a reference to the data object; and
monetizing the data object utilizing the security token in accordance with the selection;
wherein the data associated with the data object includes data independently obtained from the political campaign and associated with the user.

2. The method of claim 1, wherein the security token is a blockchain-based token utilized by a blockchain platform.

3. The method of claim 1 wherein the data object includes one or more profiles associated with the user, a website, an application, or a service and wherein at least one of the one or more profiles includes the data independently obtained from the political campaign.

4. The method of claim 1 further comprising storing the data object in a secure storage associated with the political campaign; and creating access information to the data object referenced in the security token.

5. The method of claim 4 further comprising electronically sending a receipt to the user for contribution of the data associated with the data object.

6. The method of claim 4 wherein the data independently obtained from the political campaign organization associated with the user comprises engagement data for the user within the political campaign.

7. The method of claim 6 wherein the engagement data comprises at least one of campaign event attendance, campaign donations, political party donations, and campaign participation.

8. The method of claim 1 wherein the data independently obtained from the political campaign comprises engagement data on one or more digital platforms of the political campaign.

9. The method of claim 1 further comprising trading the security token on a data exchange in exchange for monetary value.

10. The method of claim 1 further comprising:
minting non-fungible tokens (NFTs) to at least one immutable ledger and recording the minted NFT in the NFT registry wherein entries in the NFT registry correspond to programmatically defined smart contracts written to the at least one immutable ledger.

11. The method of claim 10 wherein the NFTs tokenize media files associated with the political campaigns.

12. The method of claim 11 wherein the programmatically defined smart contracts define tickets for access to campaign events.

13. The method of claim 1 further comprising generating a data refinery based on campaign data and tokenizing the campaign data to provide.

14. The method of claim 13 further comprising monetizing the campaign data.

15. A monetization platform for a political campaign comprising:
a plurality of computer systems connected via a network, where the plurality of computer systems:
form at least one immutable ledger; and
provide a non-fungible token (NFT) registry, where entries in the NFT registry correspond to programmatically defined smart contracts written to the at least one immutable ledger;
wherein at least one of the computer systems is configured as an NFT registry service, where the NET registry service is capable of:
authenticating a representative of the political campaign based in part on input received from the representative of the political campaign through the user interface;
receiving a media file through the user interface;
receiving parameters for use in programmatically defining the smart contracts wherein the parameters include at least one political campaign supporter benefit; and
minting NFTs to the at least one immutable ledger and recording the minted NTT in the NET registry, where minted NFTs are cryptographically co-signed by the NET registry service and an authenticated representative of the political campaign.

16. The monetization platform of claim 15 wherein the at least one political campaign support benefit includes a data object comprising a ticket to a campaign benefit.

17. The monetization platform of claim 16 wherein the ticket comprises an image of a two-dimensional bar code encoding ticket data.

18. The monetization platform of claim 15 wherein the at least one political campaign support benefit includes a data object comprising a coupon code for use to redeem at an online store for a physical campaign item.

19. The monetization platform of claim 18 wherein the physical campaign item comprises at least one of a sticker, a button, a sign, a shirt, and a hat.

20. A method of fundraising for a political campaign, comprising:
authenticating a representative of the political campaign based in part on input received from the representative of the political campaign through a user interface generated by a computing device;
receiving a media file through the user interface;
receiving parameters through the user interface, the parameters for use in programmatically defining smart contracts wherein the parameters include at least one political campaign supporter benefit;
minting a non-fungible token (NET) wherein the NET identifies a data object including the media file and corresponds with programmatically defined smart contracts based on the parameters.

21. The method of claim 20 further comprising selling the NTT to a campaign supporter.

22. The method of claim 20 wherein the at least one political campaign support benefit includes a ticket to a campaign benefit, the ticket contained within the data object.

23. The method of claim 22 wherein the ticket comprises an image of a two-dimensional bar code encoding ticket data.

24. The method of claim 20 wherein the at least one political campaign support benefit includes a coupon code for use to redeem at an online store for a physical campaign item, the coupon code contained within the data object.

25. The method of claim 24 wherein the physical campaign item comprises at least one of a sticker, a button, a sign, a shirt, and a hat.
